(19) United States
(12) Patent Application Publication
(10) Pub. No.: US 2010/0104354 A1
(43) Pub. Date: Apr. 29, 2010

(54) Pinned Lock Joint

(76) Inventor: Lamar Spalding, Hayward, CA (US)

Correspondence Address: Lamar Spalding, 27647 Fairview Ave, Hayward, CA, 94542, US

(21) Appl. No.: 12/260,145

(22) Filed: Oct. 29, 2008

(51) Int. Cl. F16B 12/24

(52) U.S. Cl. 403/189

(57) ABSTRACT

The Pinned Lock Joint is an improved method for joining two members together such as between a table leg and table top. A portion of the male member (the leg) is formed to completely and intimately fit into a hole or open ended slot in the female member (the top). The hole or open ended slot milled into and or through the female member is configured such that the male member can only be inserted into it along one axis of assembly, preventing disassembly along any other axis of motion. After the two members are assembled, a pin is inserted into and through both members approximately perpendicular to the axis of assembly, preventing disassembly along the original axis of assembly, and thus locking the two members together.

### BACKGROUND OF THE INVENTION

This invention relates generally to the structural joining of two separate rigid members such as might be found in an article of furniture, although it is applicable to many other constructions as well. When it is not possible to weld the two pieces together, there are a number of methods for forming the interface between two members to assist in joining them together securely. These are used in conjunction with fasteners and adhesives to either permanently or detachably join the two members. Of particular relevance to this invention are the prior methods of mechanically joining the members. The prior art includes the finger joint in which one or more machined pins with parallel sides are fit into mating open ended slots preventing disassembly in one direction only. A modification of this joint is the mortise and tenon joint having a machined pin or tenon similar to the finger joint pin, but which is mated into a hole or mortise as opposed to a open ended slot, thus preventing disassembly in all direction other than the axis of assembly. Alternately a separate dowel pin can be inserted into holes bored into both components in place of the machined tenon. The dovetail joint uses a pin configured to fit into an open ended slot, in such a manner that it can only be disassembled along one axis of motion. In all these cases an additional fastener, adhesive or both are used to prevent unintended disassembly along the original axis of assembly.

These types of joints are commonly used in the construction of tables, chairs, cabinets and other pieces of furniture where one or more horizontal members (tops, seats or shelves) must be suspended at a certain height to carry a vertical load. This is accomplished by joining vertical members (legs) to the top to adjust the height as needed. Most of these designs incorporate relatively small cross section legs of considerable relative length. The long length can lead to very highly leveraged loads at the joint holding the top to the leg, leading to joint failure.

The durability and cost to deliver a product using any given joint design depends upon (1) the quantity of material used, (2) the type and quality of materials used, (3) the difficulty to manufacture the components, (4) the difficulty to assemble the components, and (5) the cost to ship the product to the end user.

To reduce costs, the legs that support the top are often made of relatively small cross-section because the compressive strength of the material is high relative to the vertical loads to be supported. Prior to the present invention, methods for directly joining the legs to the top have resulted in weak joints prone to failure when typical leveraged loads are applied to the legs. In these designs the leg is directly joined to the underside of the table or to the edge of the table using some form of fastener or connector. These connectors are most commonly glued and/or screwed to the table top, and lit to the legs, resulting in a weak, joint. To overcome this weakness, the legs are frequently joined to a frame of some sort and then the top is separately joined to the frame.

The frame typically consists of two or more members joined to each leg to provide lateral support in at least two directions. On a typical rectangular table or chair seat, four legs are positioned at the corners of a rectangular frame. The frame is joined to each leg in two directions most commonly perpendicular to each other providing the lateral strength.

A drawback to the use of a frame instead of directly joining the legs to the top is that it is more expensive. The frame increases the amount of material used. Each new piece requires additional machining. Then more time is required to assemble the frame to the legs, and then finally additional time to assemble the top to the frame.

The simplest method of joining the legs to the frame is a butt joint wherein the face of the leg is simply glued to the face of the frame. This is weak and fails quickly under relatively low loads. To add support, braces and mechanical fasteners such as bolts and screws can then be added increasing manufacturing costs. Finally complex joints such as the finger, mortise and tenon, dowel pin or dovetail and variations thereof can be used to improve the mechanical strength. While these joints significantly improve the strength of the joints, they are far more difficult to manufacture and assemble with the precision required to assure the required strength. They also reduce the cross-section of members in the area of the joint reducing the material strength in each component in the area of the joint itself. The general result of these limitations is that inexpensive mass produced furniture uses relatively inexpensive materials and joinery techniques leading to relatively short life before failure under load. As the quality of materials and cost of manufacture rises, the durability of the article increases.

The pinned lock joint overcomes these limitations and consequently offers a method for producing a more durable connection at lower cost. The joint does this by reducing the amount of material required, reducing the complexity and time for component fabrication, reducing the assembly time and finishing time, and reducing the cost to deliver the product to the end user.

To reduce the quantity of material used, the top itself replaces the frame, and performs the same functions as the frame by securely supporting the leg against the leveraged loads. The design of the top, the materials used, the position and number of legs can be designed to accommodate the expected loads while still reducing the overall amount of material required. Eliminating the frame reduces the quantity of material required and the consequent costs (1) to store the materials, (2) of scrap loss incurred through waste and defects, (3) of product weight, and hence transportation costs.

Eliminating the frame also eliminates the fabrication time to produce the joints between the legs and the frame, and then to join the frame to the top. Eliminating these joints eliminates the need for the fasteners and adhesives required to join the frame to both the legs and the top. This reduces both the number of machining operations, and the number of assembly steps, hence the overall time to manufacture. It also reduces the complexity of tooling used to fabricate the joints and to assemble the frame.

The pinned lock joint can use a leg profile which is essentially unchanged throughout its entire length. There is no need to create a specialized joint profile separate from the leg profile. Making the profile continuous lends itself to very simple setups and high volume fabrication. The profile can be produced in long lengths, prefinished and stored for later use when the profiles are cut to length for final assembly. In fact, should the leg profile be circular, there are a wide variety of readily available and relatively inexpensive precision manufactured profiles well suited for use as legs.

Similarly, cutting the mating hole in the table top is a relatively simple one cut per joint operation accomplished with a router hit or drill. The only requirement is that the hole or slot be of identical profile and dimension as the leg profile to secure a tight fit between the mating components. Again if a circular leg profile is used this could be no more difficult than drilling holes in the top that closely match the diameter of the leg profile.

Assembly time is simplified as well. In traditional joinery, the pins and holes in the legs and frame members must be separately and precisely fabricated and then fit together. Should there be any error in machining the components will not fit together well and the joint will be weakened. These joints are then held together with connectors and pins, screws and/or adhesives adding to the assembly time. In many cases these pins and adhesives are an essential part of the joint's structure and its resistance to the leveraged loads applied to it.

In the pinned lock joint this is no longer the case, and the joint between the two members provides the structure needed to resist the leveraged loads. While the leg must fit precisely into the mating top, the alignment along the axis of assembly is adjustable at the time of assembly, making it easier to assure precision in the final assembly. Once the leg is assembled into the hole or slot, it is structurally secure against the leveraged loads, and it only needs to be locked into position to prevent unintended disassembly.

Because the locking pin is only used to prevent unintended disassembly by motion of the leg along its axis of assembly to the top, there are no forces acting to cause the pin to loosen and come out. This significantly reduces the structural requirements and the attendant manufacturing costs for the pin and its attachment. There is no need to add screw threads to the pin or other mechanical means to hold it in place. Similarly there is no need to use an adhesive eliminating a series of manufacturing steps related to the application, curing and cleanup of the adhesive before any final finishing can take place.

Finally since there are no need for adhesives the components can be shipped unassembled and readily assembled by the end user. This significantly reduces the size and shape of the article to be shipped reducing direct shipping and storage costs. Since the joints are not assembled prior to shipping, they are not subject to damage during shipping and therefore indirect shipping costs are reduced as well.

### BRIEF SUMMARY OF INVENTION

A method for joining two rigid members at an angle to each other comprised of a profile on the male member which closely mates with a corresponding hole or open ended slot in the female member. After assembly the male and female components are assembled, a pin is inserted through both components approximately perpendicular to the axis of assembly. Socking the two members together. The novelty in this invention is that its method for joining the two members reduces material usage and complexity of manufacture without sacrificing strength of the joint.

### DETAILED DESCRIPTION

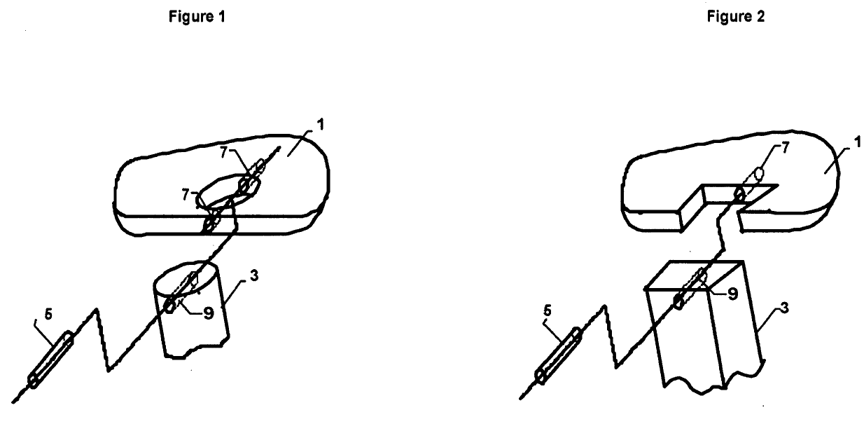

One embodiment of the joint is shown in FIGS. 1, through 5 wherein the joint is used in eight places to connect four table legs to a table top and a table shelf. Each joint in made up of 3 members, the top (1), or shelf (7), the leg (3), and the pin (5), Each individual member is constructed to mate with the other two members in an intimate manner.

In this embodiment the top member is made from wood and is 24 inches in diameter, and ¾ inches in diameter, although neither of these features is essential to the implementation of this design. The top only needs have features large enough to completely surround the mating leg (FIG. 2), be amenable to precision forming or machining, and be of sufficient strength for the anticipated application. Into the top and at an angle of 10 degrees (9) to the face of the top 4 dovetail slots (FIG. 2 and FIG. 5) are machined immediately adjacent to edge and through the top at 90 degree intervals around the top. The 10 degree angle (9) is only pertinent to this particular design and could be varied significantly in either a positive or negative direction as shown in FIGS. 9 and 10 without impacting the joint's functionality. The dovetail slot has a depth of ¾ inch, but again this is not critical to the joint design. The depth need only be sufficient to provide the strength needed for the application. The dovetail slot has a race (11) and two sides (13, 15) at angles of 80 and 100 degrees to the face, and is cut using a router bit shaped in this profile. This method provides a fast repeatable mechanism for creating a precision open ended slot, but again is not essential to the design. The critical feature is that the shape of the open ended slot is such the leg can only be inserted into along one axis of motion.

The shelf is similar to the top. It is also made of wood, and ¾ inches thick but it is smaller in diameter at 20 inches because of 10 degree angle of the dovetail slots in both the top and shelf. The shelf is not an essential feature of the joint design, and the legs can be joined to the top alone, eliminating the use of a shelf entirely. In a similar fashion four identical dovetail slots are cut of the same size and at the same 10 degree angle into the shelf at 90 degree intervals.

The four legs are also made of wood although this is not essential to the design, one for each open ended slot in the top and shelf, and they are identical in all respects. In cross section the legs are cut so that they are identical in form and dimension to the dovetail slots. Each has one flat face (17) equal in length to the face (11) of the slot cut into the table top. It has 2 sides (19 and 21) with angles of 80 and 100 degrees to the face identical to those of the slot (13 and 15) in the top and shelf. This is readily accomplished using the same router bit used to cut the open ended slots in the top and shelf; assuring that the angles on the legs are an exact match to the slots. The legs are then cut to length as needed.

The next step is to assemble the legs (3) to the shelf (7) and top (1). This is accomplished by sliding the legs through the slots in the top and shelf. At the top, the legs stop with the ends flush and parallel to the top, although they could extend beyond the top without affecting the design. The shelf is placed such that all four legs are located in and through the slots in the shelf and the shelf is parallel to the top. This is most easily accomplished with the use of a gauge which rests on the underside of the top and whose length is precisely the distance the shelf needs to be from the top to accommodate the legs while remaining parallel to the shelf.

Once the legs are in position, they are temporarily clamped into place to prevent them from movement during the final assembly. Once clamped a 5/16 inch diameter hole (23) is drilled from the outside of each leg and at a 87 degree angle to the leg with the center located ⅜ inch below the top surface of the top or shelf and centered at the midpoint of the width of the outside of the leg. The hole is drilled entirely through the leg and ½ inch into the top (25) or shelf. After the hole is drilled, a 5/16 inch diameter wooden dowel (5) is driven into the hole thus locking the leg into the top. This process is repeated for all seven remaining joints in the top and shelf. Once completed the legs are now permanently locked to both the top and the shelf and the assembly functions as a rigid unit.

To reduce shipping costs, once the holes for the locking pins are drilled through both the leg and the top and shelf, the components can be disassembled, and packaged flat for shipping. Then the end user can assemble the components, and drive the pins in place to lock them together. While this embodiment uses a wooden dowel pin, the same functionality could be accomplished with a nail or a screw or other form of rigid pin.

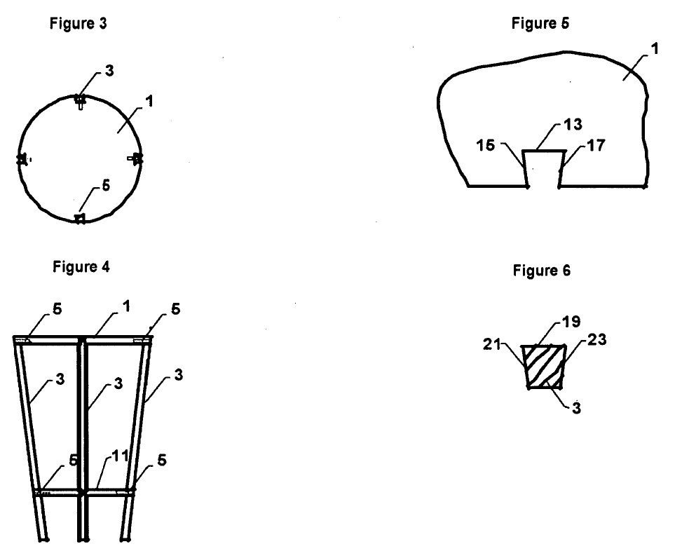

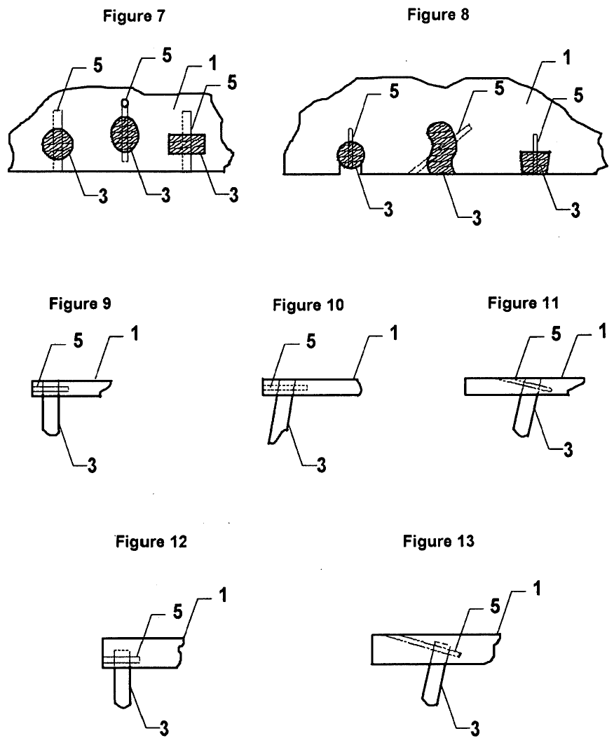

This is one embodiment of this joint; there are many potential variations. The open ended slot cut into the edge of the top needs only have the ability to prevent assembly with the leg in all but one axis of motion, and thus could be of many shapes or configurations such as a key hole, or other variation as shown in FIGS. 6, 7.

There is no need for the joint to be located at the edge of the top or shelf using an open-ended slot. The same functionality can be accomplished with a closed hole of any configuration desirable, so long as the mating leg can be shaped to intimately conform in shape and dimension to the hole and the top and leg can be machined such that a pin can be inserted though each component after assembly to lock the pieces together. Furthermore the hole or open ended slot does not need to go completely through the top or shelf, and could stop short remaining invisible from the top side.

There is no need to manufacture the components from wood. The three components could be made of metal, plastic, glass, stone or any other sufficiently strong rigid material or combination thereof capable of being precisely machined or formed.

There is no dimensional constraint on the top or optional shelf other than that it be large enough to fully encapsulate the leg. The same is true of the leg, and it only need to have sufficient material at the point of interface to fit intimately into the mating open ended slot or hole. There is no dimensional constraint on the open ended slot or hole other than it must be sufficiently large to accommodate a mating leg and a pin through the leg and top.

The pin can be of any form, material, and dimension so long as it can penetrate completely through the both members, and be rigid enough to resist any forces applied to it. There is no requirement that a hole be pre-drilled through the leg and into the top. A screw or nail could be used instead of a dowel pin eliminating the need for these holes.

This joint design has been developed for use in the construction of articles of furniture, but it could be applied to any situation in which a broad plane needs to be joined to a relatively small cross section member. One possible use would be to join the rungs (shelves) to the rails (legs) in a ladder.

The invention claimed is:

1. A locked pinned joint comprising:
A rigid first member with at least one portion with a cross-section configured to mate frictionally, intimately and completely with a hole cut into the second member,
A rigid second member with a hole cut onto it
a. Said hole is formed into the second member to align the first member to it as desired.
b. Said hole is configured to completely, intimately and frictionally conform to the first member in both dimension and shape such that the two members when assembled cannot be moved relative to each other except along the one axis of assembly.
c. Said hole is to be located such that a rigid third member can be placed approximately perpendicular to the axis of assembly of the first two members and simultaneously through both the first and second members after they have been assembled together,
A rigid third member of cross-section and length such that it can be assembled through the both the first and second members at the location where the two meet
d. Said third member is intimately and frictionally fit to the assembled first and second members so as to prevent its unintended removal from the first and second members
e. Said third member is placed in such a manner that upon assembly the movement of the first two members relative to each other along their axis of assembly is no longer possible.

2. A locked pinned joint of claim 1 wherein the second member has an open-ended slot.
f. Said open-ended slot is formed into the second member to align the first member to it
g. Said open-ended slot is configured to completely, intimately and frictionally conform to the first member in both dimension and shape such that the two members when assembled cannot be moved relative to each other except along the one axis of assembly,
h. Said open-ended slot to be located such that a third member can be placed approximately perpendicular to the axis of said open-ended slot and through both the first and second members after they have been assembled.

3. A locked pinned joint of claims 1 or 2 wherein the first member has a continuously unvaried cross-section allowing multiple second members to be joined to it.

4. A locked pinned joint of claims 1 or 2 wherein the first member has a tapered cross-section allowing multiple second members to be joined to it.

5. A locked pinned joint of claims 1 or 2 wherein the first member has a cross-section at one end allowing the second member to be joined only to that end of the first member.
a. Said first member having a larger cross section in the area immediately adjacent to the area of joining providing additional support for load normal to the axis of assembly.

6. A locked pinned joint of claims 1 and 2 wherein the hole or slot does not penetrate through both sides of the second member.

7. A locked pinned joint of claims 1 or 2 wherein the hole or open ended slot is cut at an angle of between 30 and 90 degrees inclusive to the face of the second member.

8. A locked pinned joint of claim 1 or 2 wherein the third member is a rigid pin intimately and frictionally fit into a hole machined through both the first and second members after they have been assembled.

9. A locked pinned joint of claim 1 or 2 wherein the third member is a nail driven through the first and second members after they have been assembled.

10. A locked pinned joint of claim 1 or 2 wherein the third member is a screw driven through the first and second members after they have been assembled.
